(19) United States
(12) Patent Application Publication
(10) Pub. No.: US 2025/0264776 A1
(43) Pub. Date: Aug. 21, 2025

(54) CAMERA MODULE

(71) Applicant: SAMSUNG ELECTRONICS CO., LTD., Suwon-si (KR)

(72) Inventors: Yongsik CHO, Suwon-si (KR); Kwanghyung Kim, Suwon-si (KR); Dongjoon Won, Suwon-si (KR); Minook Kim, Suwon-si (KR); Jinmyoung Mok, Suwon-si (KR); Seung Hak Lee, Suwon-si (KR); Younggyu Jung, Suwon-si (KR); Kyungsung Chu, Suwon-si (KR)

(73) Assignee: SAMSUNG ELECTRONICS CO., LTD., Suwon-si (KR)

(21) Appl. No.: 18/972,256

(22) Filed: Dec. 6, 2024

(30) Foreign Application Priority Data
Feb. 20, 2024 (KR) 10-2024-0024585

(51) Int. Cl. G03B 11/04; G02B 13/00; G02B 17/08; G03B 30/00

(52) U.S. Cl. CPC G03B 11/045; G02B 13/002; G02B 17/0856; G03B 30/00

(57) ABSTRACT

A camera module includes a lens assembly including a plurality of lenses along a first optical path, and an image sensor including an image surface and provided at one side of the lens assembly, where the plurality of lenses include a first lens including a first hole through a center thereof, a second lens adjacent to an image-side surface of the first lens, the second lens configured as a reflective type lens, and including a second hole through a center thereof, a third lens adjacent to the first lens and configured as a reflective type lens, a fourth lens adjacent to an image-side surface of the third lens, and a fifth lens adjacent to an image-side surface of the fourth lens.

### CROSS-REFERENCE TO RELATED APPLICATIONS

This application is based on and claims priority to Korean Patent Application No. 10-2024-0024585, filed on Feb. 20, 2024, in the Korean Intellectual Property Office, the disclosure of which is incorporated by reference herein in its entirety.

### BACKGROUND

Example embodiments of the disclosure relate to a camera module including a lens assembly with a plurality of lenses.

Recently, imaging devices are decreasing in size and are capable of acquiring images that are higher in resolution. Camera modules provided on electronic devices may also be required to have high optical performance and to be small in size. Particularly, in the case of a camera module that is provided on small electronic devices, such as a mobile phone, the camera module may be required to have high magnification characteristics while having a small size.

However, a total track length (TTL) from a focus to a first lens surface of an optical system may be very short, and thus, an appropriate optical path may not secured, resulting in defects such as flare.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more example embodiments provide a camera module capable of realizing high magnification while being small in size and capable of preventing defects such as flare.

Additional aspects will be set forth in part in the description which follows and, in part, will be apparent from the description, or may be learned by practice of the presented embodiments.

According to an aspect of an example embodiment, a camera module may include a lens assembly including a plurality of lenses along a first optical path, and an image sensor including an image surface and provided at one side of the lens assembly, where the plurality of lenses may include a first lens including a first hole through a center thereof, a second lens adjacent to an image-side surface of the first lens, the second lens configured as a reflective type lens, and including a second hole through a center thereof, a third lens adjacent to the first lens and configured as a reflective type lens, a fourth lens adjacent to an image-side surface of the third lens, and a fifth lens adjacent to an image-side surface of the fourth lens, and the camera module satisfies 4>f/TTL>0.5 and 0.75>D1/CA>0.4, where f corresponds to a total effective focal length of the lens assembly, TTL corresponds to a total track length from an object-side surface of the first lens to the image surface of the image sensor, CA corresponds to an effective diameter of the object-side surface of the first lens, and D1 corresponds to a diameter of the first hole.

According to an aspect of an example embodiment, a lens assembly may include a plurality of lenses along an optical path, the plurality of lenses including a first lens including a first hole through a center thereof, a second lens adjacent to an image-side surface of the first lens, the second lens configured as a reflective type lens, and including a second hole through a center thereof, a third lens adjacent to the first lens and configured as a reflective type lens, a fourth lens adjacent to an image-side surface of the third lens, and a fifth lens adjacent to an image-side surface of the fourth lens, and where the lens assembly satisfies 4>f/TTL>0.5, 0.75>D1/CA>0.4, and 0.75>D2/CA>0.4, where f corresponds to a total effective focal length of the lens assembly, TTL corresponds to a total track length from an object-side surface of the first lens to a focus of the lens assembly, CA corresponds to an effective diameter of the object-side surface of the first lens, D1 corresponds to a diameter of the first hole, and D2 corresponds to a diameter of the second hole.

According to an aspect of an example embodiment, an electronic device may include a camera module configured to obtain an image by photographing an object, a processor configured to control the camera module to process the image, and a memory configured to store the image, where the camera module may include a lens assembly including a plurality of lenses along an optical path, and an image sensor including an image surface, where the plurality of lenses may include a first lens including a first hole through a center thereof, a second lens adjacent to an image-side surface of the first lens, the second lens configured as a reflective type lens, and including a second hole through a center thereof, a third lens adjacent to the first lens and configured as a reflective type lens, a fourth lens adjacent to an image-side surface of the third lens, and a fifth lens adjacent to an image-side surface of the fourth lens, and where the camera module satisfies 4>f/TTL>0.5 and 0.75>D1/CA>0.4, where f corresponds to a total effective focal length of the lens assembly, TTL corresponds to a length from an object-side surface of the first lens to the image surface of the image sensor, CA corresponds to an effective diameter of the object-side surface of the first lens, and D1 corresponds to a diameter of the first hole.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a block diagram illustrating an electronic device including a camera module according to one or more embodiments;

FIG. 2 is a block diagram illustrating a camera module according to one or more embodiments;

FIG. 3 is a cross-sectional view illustrating a camera module according to one or more embodiments;

FIG. 4 is a cross-sectional view illustrating a lens assembly, an optic device, and an image sensor of a camera module according to one or more embodiments;

FIG. 5 is a cross-sectional view illustrating a camera module and illustrating a normal path and an abnormal path of a light incident into the camera module according to one or more embodiments;

FIG. 6 is a cross-sectional view illustrating a camera module and illustrating a normal path and an abnormal path of a light incident into the camera module according to one or more embodiments;

FIG. 7 is a cross-sectional view illustrating a camera module according to one or more embodiments;

FIG. 8 is a graph illustrating a longitudinal spherical aberration, astigmatic field curves, and a distortion aberration of a lens assembly according to one or more embodiments;

FIG. 9 is a cross-sectional view illustrating a lens assembly according to one or more embodiments;

FIG. 10 is a graph illustrating a longitudinal spherical aberration, astigmatic field curves, and a distortion aberration of a lens assembly according to one or more embodiments;

FIG. 11 is a cross-sectional view illustrating a lens assembly according to one or more embodiments; and

FIG. 12 is a graph illustrating a longitudinal spherical aberration, astigmatic field curves, and a distortion aberration of a lens assembly according to one or more embodiments.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

The present disclosure relates to a camera module including a lens assembly. The camera module is an electronic device that receives a light with a wavelength in a specified range from an external object and generates an image of the external object corresponding to the received light.

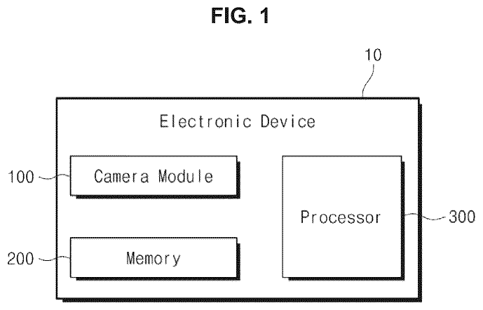

FIG. 1 is a block diagram illustrating an electronic device including a camera module according to one or more embodiments.

Referring to FIG. 1, the electronic device 10 may include the camera module 100, a memory 200, and a processor 300.

The camera module 100 may be provided in singular or plural depending on the electronic device 10. In one or more embodiments, when the electronic device 10 a mobile phone, the camera module 100 may be provided as a single module or in two or more modules and may be provided on a front surface and/or a rear surface of the mobile phone.

The camera module 100 may receive a light of various wavelengths, such as a visible light and/or an infrared light, traveling thereto from the outside. The camera module 100 may obtain an image of an external object (i.e., a subject) by generating an electrical signal corresponding to the received light.

The camera module 100 may transmit the generated image to the processor 300. In one or more embodiments, the camera module 100 may compress or encode the generated image and may transmit the compressed or encoded image to the processor 300 through a specified interface.

The memory 200 may store image files, specified files, or specified instructions related to operations performed by the processor 300. In one or more embodiments, the memory 200 may store the image of an external object or may store instructions related to the operation of the processor 300, which controls the camera module 100 to generate the image of the external object. The memory 200 may transmit the stored files or instructions to the processor 300 through the specified interface.

The processor 300 may be electrically connected to components included in the electronic device 10 and may perform operations or data processing related to control and/or communication of the components included in the electronic device 10. In one or more embodiments, the processor 300 may execute the instructions stored in the memory 200 to process the image obtained by the camera module 100. In particular, the processor 300 may control the camera module 100 to obtain the image of the external object.

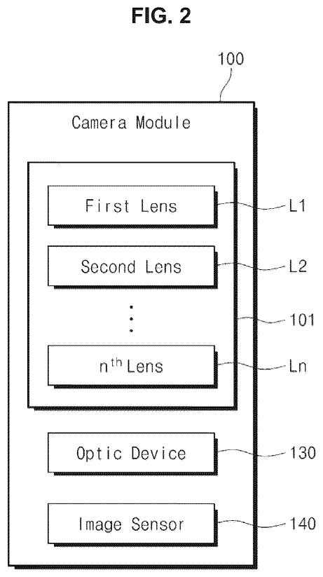

FIG. 2 is a block diagram illustrating a camera module according to one or more embodiments.

Referring to FIG. 2, the camera module 100 may include a lens assembly 101, an optic device 130, and an image sensor 140. The above components of the camera module 100 may be arranged in the order of the lens assembly 101, the optic device 130, and the image sensor 140 along a path of a light incident from the outside. According to one or more embodiments, one or more components of the camera module 100 may be omitted, or the camera module 100 may further include components not shown in FIG. 2. In one or more embodiments, the camera module 100 may further include an image signal process (ISP) to process the image obtained by the image sensor 140 and may further include an interface to transmit data to the processor 300.

The lens assembly 101 may include a plurality of lenses, such as n lenses, where n is a natural number equal to or greater than 2. The lenses of the lens assembly 101 may be sequentially arranged along the path of the light incident thereto from the outside and may include a first lens L1, a second lens L2, . . . , to an n-th lens Ln. In one or more embodiments, the number of the lenses included in the lens assembly 101 may be six, however, embodiments are not limited thereto. For example, the camera module 100 may include one lens assembly 101. According to one or more embodiments, the camera module 100 may include two or more lens assemblies.

The lenses of the lens assembly 101 may condense the light incident thereto from the outside. In one or more embodiments, the lenses of the lens assembly 101 may refract and reflect the light incident thereto to condense the light on a predetermined position in the image sensor 140. The refracted and reflected light may be condensed on the predetermined position in the image sensor 140 after passing through the optic device 130.

The image sensor 140 may generate an image (or image data) corresponding to the light passing through the optic device 130. The image sensor 140 may include a plurality of pixels. The pixels may generate an electrical signal (e.g., a current) that is the basis of the image in response to the received light. The image generated based on the electrical signal may be transmitted to the processor 300 through the specified interface.

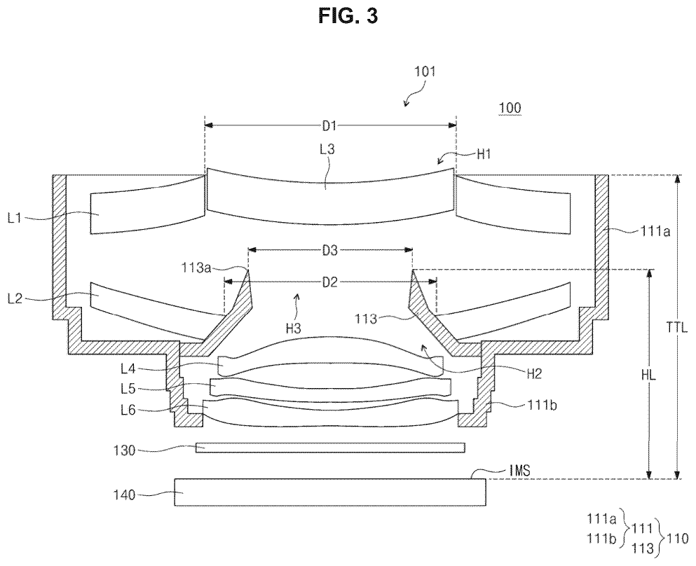

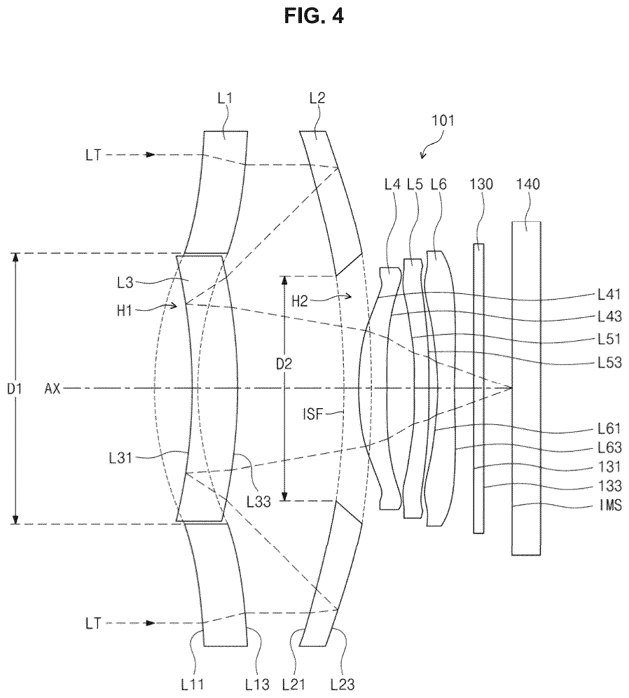

FIG. 3 is a cross-sectional view illustrating a camera module according to one or more embodiments. FIG. 4 is a cross-sectional view illustrating a lens assembly, an optic device, and an image sensor of a camera module according to one or more embodiments. FIG. 4 illustrates a camera module without a housing.

Referring to FIGS. 3 and 4, the camera module 100 may include the lens assembly 101, the optic device 130, the image sensor 140, and the housing 110. The housing 110 may accommodate the lens assembly 101, the optic device 130, and the image sensor 140 therein.

According to one or more embodiments, the lens assembly 101, the optic device 130, and the image sensor 140 are arranged sequentially in a direction away from the subject. The image sensor 140 may include an image surface IMS on which a light LT incident through the lenses and the optic device 130 is formed.

As described herein, an image-side may indicate, for example, a direction toward the image surface IMS where the image is formed, and an object-side may indicate a direction toward the object. In addition, an “object-side surface” of a lens may indicate, for example, a left side in FIG. 4, which corresponds to a surface of the lens facing the object based on an optical axis AX, and an “image-side surface” may indicate a right side in FIG. 4, which corresponds to a surface of the lens facing the image surface IMS based on the optical axis AX. The image surface IMS may be a surface of an imaging device or a surface of the image sensor 140.

The image sensor 140 may be implemented with a charge-coupled device (CCD) or a complementary metal-oxide-semiconductor (CMOS). However, the image sensor 140 is not limited thereto, and in one or more embodiments, the image sensor 140 may be implemented with various devices that convert the image of the object into electrical image signals.

The lenses of the lens assembly 101 may be arranged sequentially along an optical path from the outside to the image surface IMS of the image sensor 140. The lens assembly 101 may include, for example, at least two or more lenses. In one or more embodiments, the lens assembly 101 may include first, second, third, fourth, fifth, and sixth lenses L1, L2, L3, LA, L5, and L6 arranged sequentially along the optical path.

Hereinafter, the lens assembly 101 is described as including six lenses as an example, but embodiments are not limited thereto. In one or more embodiments, the lens assembly 101 may include fewer or more than six lenses.

The lenses may include transmissive type lenses and reflective type lenses. Each reflective type lens may be a lens of which at least a portion of the lens acts as a reflective surface. The reflective type lens may include the object-side surface or the image-side surface as its reflective surface. As some lenses are provided as the reflective type lenses, a physical arrangement of the first, second, third, fourth, fifth, and sixth lenses L1, L2, L3, LA, L5, and L6 may vary depending on the optical path. According to one or more embodiments, two lenses may be provided as the reflective type lenses and the optical path may vary, and thus, a sufficient optical path may be secured for a high-magnification lens. In particular, a total track length (TTL) from a focus to one surface of the first lens L1 may decrease, and a value of an effective focal length (Fno) may increase when compared with a case where the first, second, third, fourth, fifth, and sixth lenses L1, L2, L3, L4, L5, and L6 are arranged sequentially in a straight line without the reflective type lens. Accordingly, a size of the lens assembly 101 may be reduced, and thus, the camera module 100 may be miniaturized, and a brighter lens may be implemented.

In one or more embodiments, among the first, second, third, fourth, fifth, and sixth lenses L1, L2, L3, L4, L5, and L6, the first lens L1, the fourth lens L4, the fifth lens L5, and the sixth lens L6 may be the transmissive type lens, and the second lens L2 and the third lens L3 may be the reflective type lens. The first lens L1, the fourth lens L4, the fifth lens L5, and the sixth lens L6 that are the transmissive type lens may be arranged sequentially along the optical axis AX from the object (subject) to the image surface IMS of the image sensor 140. The second lens L2 and the third lens L3 that are the reflective type lens may be arranged sequentially along the optical axis AX from the object (subject) to the image surface IMS of the image sensor 140, and may be arranged adjacent to the transmissive type lenses to surround the transmissive type lenses.

The first lens L1 may have a positive refractive power. The first lens L1 may include an object-side surface L11 and an image-side surface L13, which face opposite directions, respectively. The object-side surface L11 of the first lens L1 may face the object (subject), and the image-side surface L13 of the first lens L1 may face the image surface IMS of the image sensor 140. The first lens L1 may be provided in a ring shape with a first hole H1 penetrating a center thereof. The first hole H1 may have a first diameter D1.

The image-side surface L13 of the first lens L1 may have a concave shape. In one or more embodiments, the object-side surface L11 of the first lens L1 may have a convex shape, and the image-side surface L13 of the first lens L1 may have the concave shape. The first lens L1 may be a spherical lens or an aspherical lens. When the first lens L1 is the spherical lens, the object-side surface L11 and the image-side surface L13 of the first lens L1 may be spherical, and when the first lens L1 is the aspherical lens, the object-side surface L11 and the image-side surface L13 of the first lens L1 may be aspherical. The first lens L1 may be formed of, for example, a glass or plastic material.

The second lens L2 may include an object-side surface L21 and an image-side surface L23, which face opposite directions, respectively. The object-side surface L21 of the second lens L2 may face the object (subject), and the image-side surface L23 of the second lens L2 may face the image surface IMS of the image sensor 140. The image-side surface L23 of the second lens L2 may have a convex shape. In one or more embodiments, the object-side surface L21 of the second lens L2 may have a concave shape, and the image-side surface L23 of the second lens L2 may have the convex shape.

The second lens L2 may be the reflective type lens, and the -image-side surface L23 of the second lens L2 may include the reflective surface. The image-side surface L23 of the second lens L2 may reflect a light incident thereto from the object-side surface L21 of the second lens L2 to the third lens L3. The second lens L2 may be provided in a ring shape with a second hole H2 penetrating through a center thereof. The second hole H2 may have a second diameter D2.

The second lens L2 may be a spherical or aspherical lens. In one or more embodiments, the object-side surface L21 and the image-side surface L23 of the second lens L2 may be aspherical. The second lens L2 may be formed of, for example, a plastic material.

The third lens L3 may be disposed adjacent to the first lens L1. The third lens L3 may include an object-side surface L31 and an image-side surface L33, which face opposite directions, respectively. The object-side surface L31 of the third lens L3 may face the object (subject), and the image-side surface L33 of the third lens L3 may face the image surface IMS of the image sensor 140. The object-side surface L31 of the third lens L3 may have a concave shape. In one or more embodiments, the object-side surface L31 of the third lens L3 may have a concave shape, and the image-side surface L33 of the third lens L3 may have a convex shape.

The third lens L3 may be the reflective type lens, and the object-side surface

L31 of the third lens L3 may include the reflective surface. The object-side surface L31 of the third lens L3 may reflect a light incident thereto from the image-side surface L33 of the third lens L3 to the fourth lens L4.

The third lens L3 may be a spherical or aspherical lens. In one or more embodiments, the object-side surface L31 and the image-side surface L33 of the third lens L3 may be aspherical. The third lens L3 may be formed of, for example, a plastic material.

The third lens L3 may be disposed to overlap the first hole H1 of the first lens L1 in a direction substantially parallel to the optical axis AX of the camera module 100. The third lens L3 may entirely overlap the first hole H1 in the direction substantially parallel to the optical axis AX, and in one or more embodiments, the third lens L3 may be disposed in the first hole H1. In this case, the third lens L3 may have a diameter equal to or smaller than the first diameter D1 so that the third lens L3 is disposed in the first hole H1.

According to one or more embodiments, the first lens L1 and the third lens L3 may be provided as separate lenses.

The fourth lens L4 may have a negative refractive power. The fourth lens LA may include an object-side surface L41 and an image-side surface L43, which face opposite directions, respectively. The object-side surface L41 of the fourth lens LA may face the object (subject), and the image-side surface L43 of the fourth lens L4 may face the image surface IMS of the image sensor 140. The image-side surface L43 of the fourth lens L4 may have a concave shape. In one or more embodiments, the object-side surface LA1 of the fourth lens L4 may have a convex shape, and the image-side surface L43 of the fourth lens L4 may have a concave shape. The fourth lens L4 may be an aspherical lens, and the object-side surface L41 and the image-side surface L43 of the fourth lens L4 may be aspherical. The fourth lens L4 may be formed of, for example, a plastic material.

The fourth lens L4 may be disposed to overlap at least a portion of the second hole H2 of the second lens L2 in the direction substantially parallel to the optical axis AX or may be disposed adjacent to the second hole H2 without overlapping the second hole H2. In one or more embodiments, the fourth lens L4 may overlap the second hole H2. In one or more embodiments, the fourth lens L4 may be disposed in the second hole H2. However, the fourth lens L4 may be provided in a position biased toward the image sensor 140 rather than inside the second hole H2. FIG. 4 shows a structure in which the fourth lens L4 partially overlaps the second hole H2 of the second lens L2.

The fifth lens L5 may have the positive refractive power. The fifth lens L5 may include an object-side surface L51 and an image-side surface L53, which face opposite directions, respectively. The object-side surface L51 of the fifth lens L5 may face the object (subject), and the image-side surface L53 of the fifth lens L5 may face the image surface IMS of the image sensor 140. The image-side surface L53 of the fifth lens L5 may have a convex shape. In one or more embodiments, the object-side surface L51 of the fifth lens L5 may have a concave shape, and the image-side surface L53 of the fifth lens L5 may have a convex shape. The fifth lens L5 may be an aspherical lens, and the object-side surface L51 and the image-side surface L53 of the fifth lens L5 may be aspherical. The fifth lens L5 may be formed of, for example, a plastic material.

The sixth lens L6 may have the negative refractive power. The sixth lens L6 may include an object-side surface L61 and an image-side surface L63, which face opposite directions, respectively. The object-side surface L61 of the sixth lens L6 may face the object (subject), and the image-side surface L63 of the sixth lens L6 may face the image surface IMS of the image sensor 140. The image-side surface L63 of the sixth lens L6 may have a convex shape. In one or more embodiments, the object-side surface L61 of the sixth lens L6 may have a concave shape, and the image-side surface L63 of the sixth lens L6 may have a convex shape. The sixth lens L6 may be an aspherical lens, and the object-side surface L61 and the image-side surface L63 of the sixth lens L6 may be aspherical. The sixth lens L6 may be formed of, for example, a plastic material. The sixth lens L6 may be omitted.

The optic device 130 may be disposed between the sixth lens L6 and the image surface IMS of the image sensor 140. The optic device 130 may be a filter that blocks some wavelengths of the light LT incident thereto that travels through the first, second, third, fourth, fifth, and sixth lenses L1, L2, L3, L4, L5, and L6. In one or more embodiments, in a case where the image to be obtained by the image sensor 140 is a visible light image, the optic device 130 may be an infrared blocking filter that blocks an infrared wavelength of the light LT. When the infrared blocking filter is used as the optic device 130, the optic device 130 may transmit the visible light and may block the infrared light, and thus, the infrared light may not reach the image surface IMS. According to one or more embodiments, in a case where the image to be obtained by the image sensor 140 is an infrared light image, the optic device 130 may be omitted, and the lens assembly 101 may be implemented without the optic device 130.

As described above, at least one lens of the lens assembly 101 may be formed of a plastic material. According to one or more embodiments, the lens assembly 101 may include at least three plastic lenses. In one or more embodiments, all lenses included in the lens assembly 101 may be plastic lenses. Accordingly, the lens assembly 101 may be lightweight and production costs may be reduced.

According to the arrangement of the lenses described above, the light LT from the subject may travel toward the optic device 130 and the image sensor 140 through the first, second, third, fourth, fifth, and sixth lenses L1, L2, L3, L4, L5, and L6. The optical path of the light LT within the lens assembly 101 is indicated by a dotted line. The camera module 100 may be configured to increase a length of the optical path of the light LT incident into the camera module 100 without increasing an overall length of the camera module 100. In one or more embodiments, the light LT from the outside may be incident into the object-side surface L21 of the second lens L2 through the first lens L1, may be reflected by the image-side surface L23 of the second lens L2, and then may be incident into the image-side surface L33 of the third lens L3. The light LT may be incident into the fourth lens L4 after being reflected by the object-side surface L31 of the third lens L3 and may be incident into the image surface IMS of the image sensor 140 through the third, fourth, and fifth lenses L3, L4, and L5 and the optic device 130.

As described above, the light exiting from the lens assembly 101 may reach the image sensor 140 after passing through the optic device 130.

When the light reaches the image sensor 140, the image sensor 140 may obtain the image from the light LT. The image sensor 140 may include the pixels that convert the light LT incident thereto through the first, second, third, fourth, fifth, and sixth lenses L1, L2, L3, LA, L5, and L6 and the optic device 130 into the electrical signals to obtain the image. According to one or more embodiments, the image sensor 140 may be attached to a printed circuit board (PCB). The image sensor 140 may be electrically connected to the processor 300 via the PCB and may transmit the obtained image to the processor 300.

In one or more embodiments, the lenses of the lens assembly may satisfy predetermined conditions described below to realize the high magnification while being small in size.

The first lens L1 may act as an aperture within the camera module 100. The first lens L1 may have a same size (e.g., a same diameter) or a greater size than each of the second, third, fourth, fifth, and sixth lenses L2, L3, LA, L5, and L6.

In addition, the first lens L1 may have the largest effective diameter within the camera module 100. The effective diameter may refer to a diameter of a lens (or a reflective member) through which a light actually passes. In one or more embodiments, the effective diameter of the object-side surface of the first lens L1 may be greater than an effective diameter of each of the second, third, fourth, fifth, and sixth lenses L2, L3, LA, L5, and L6. In addition, the effective diameter of the object-side surface L11 of the first lens L1 and a diagonal length of the image surface IMS of the image sensor 140 may satisfy Equation (1).

$$3 > CA / DG > 0.5 \qquad ( 1 )$$

In Equation (1), CA denotes the effective diameter of the object-side surface of the first lens L1, and DG denotes the diagonal length of the image surface IMS of the image sensor 140.

The first diameter D1 of the first hole H1 of the first lens L1 may be greater than the diameter of the third lens L3. Accordingly, the third lens L3 may be disposed in the first hole H1. The second diameter D2 of the second hole H2 of the second lens L2 may be greater than a diameter of the fourth lens LA. Accordingly, a portion or all of the fourth lens LA may be disposed in the second hole H2, or the fourth lens LA may be disposed adjacent to the second hole H2.

The first hole H1 may have a size that satisfies Equation (2).

$$0.75 > D 1 / CA > 0.4 \qquad ( 2 )$$

In Equation (2), CA denotes the effective diameter of the object-side surface L11 of the first lens L1, and D1 denotes the first diameter. When the size of the first hole H1 is smaller than about 0.4 times of the effective diameter of the object-side surface L11 of the first lens L1, an amount of light traveling toward the second lens L2 may be large, but an amount of light reflected by the third lens L3 may be excessively small. In addition, when the size of the first hole H1 is greater than about 0.75 times of the effective diameter of the object-side surface L11 of the first lens L1, an amount of light incident into the first lens L1 and traveling toward the second lens L2 may be reduced, making it difficult to obtain the image.

Further, the second hole H2 may be defined through the second lens L2 to have a predetermined size, and in one or more embodiments, the size of the second hole H2 may satisfy Equation (3).

$$0.75 > D 2 / CA > 0.4 \qquad ( 3 )$$

In Equation (3), CA denotes the effective diameter of the object-side surface L11 of the first lens L1, and D2 denotes the second diameter. When the size of the second hole H2 is smaller than about 0.4 times of the effective diameter of the object-side surface L11 of the first lens L1, an amount of light reflected by the second lens L2 and traveling toward the third lens L3 may be large, but an amount of light reflected by the third lens L3 and traveling toward the fourth lens LA may be excessively small. In addition, when the size of the second hole H2 is greater than about 0.75 times of the effective diameter of the object-side surface L11 of the first lens L1, the amount of the light reflected by the second lens L2 may be reduced.

According to one or more embodiments, the lens assembly 101 may satisfy Equation (4).

$$4 > f / TTL > 0.5 \qquad ( 4 )$$

In Equation (4), f denotes a total effective focal length of the lens assembly 101, and TTL denotes the length from the object-side surface L11 of the first lens L1 to the image surface IMS of the image sensor 140 on the optical axis AX. When a focus is on the image surface IMS of the image sensor 140, TTL corresponds to a length from the object-side surface L11 of the first lens L1 to the focus of the lens assembly 101.

The camera module 100 may implement an autofocus function by moving the first, second, third, fourth, fifth, and sixth lenses L1, L2, L3, LA, L5, and L6. In one or more embodiments, the camera module 100 may implement the autofocus function by moving the first, second, third, fourth, fifth, and sixth lenses L1, L2, L3, LA, L5, and L6 in a direction substantially parallel to the optical axis AX.

The housing 110 may accommodate the lens assembly 101 therein. The housing 110 may include a cylindrical portion 111 that supports the lenses at an edge of the lenses and a hood portion 113 that protrudes from an inner side surface of the cylindrical portion 111 toward the object.

The cylindrical portion 111 may have at least one stepped portion on which the lenses are placed to support the edge of each lens. The cylindrical portion 111 may have an inner diameter that varies depending on the diameter of each lens. In one or more embodiments, the cylindrical portion 111 may include a first cylindrical portion 111a that supports the first lens L1 and the second lens L2, which have a relatively large diameter, and a second cylindrical portion 111b that supports the third, fourth, fifth, and sixth lenses L3, L4, L5, and L6, which have a relatively small diameter. The cylindrical portion 111 may be provided in a single integral body without being divided into multiple portions, however, embodiments are not limited thereto. According to one or more embodiments, the cylindrical portion 111 may include multiple separated portions and may be provided in an assembled form. In addition, additional portions may be provided to effectively support and secure each lens.

The hood portion 113 may have a ring shape that protrudes from the inner side surface of the first cylindrical portion 111a and/or the second cylindrical portion 111b toward a center of the cylindrical portion 111. The hood portion 113 may be provided with a third hole H3 defined through a center thereof and having a third diameter D3.

The hood portion 113 may be assembled with the first and/or second cylindrical portions 111a and 111b after being separately manufactured, however, embodiments are not limited thereto. The hood portion 113 may be integrally provided with the first and/or second cylindrical portions 111a and 111b without being separated from the first and/or second cylindrical portions 111a and 111b.

The hood portion 113 may block the light that is incident through the first lens L1 from traveling through a path other than a path through which the light is incident into the fourth lens L4 after being reflected by the second lens L2 and the third lens L3. When the path of the light that is incident into the first lens L1 and travels to the image sensor 140 after sequentially passing through the second, third, fourth, fifth, and sixth lenses L2, L3, L4, L5, and L6 is referred to as a normal path and a path of the light that is incident into the first lens L1 and travels to the image sensor 140 by taking a path rather than the normal path is referred to as an abnormal path, the hood portion 113 may block the light traveling through the abnormal path.

The hood portion 113 may be placed on the abnormal path. In one or more embodiments, the hood portion 113 may be placed on the optical path of the light that goes directly from the first lens L1 to the fourth lens L4 win a cross-sectional view. The protruded portion 113a of the hood portion 113 may block the light that travels from the first lens L1 directly to the fourth lens L4.

In a cross-sectional view, the hood portion 113 may extend in a direction toward the third lens L3 after penetrating the second hole H2 of the second lens L2 from the image-side surface L23 to the object-side surface L21 to block the light that travels straight to the fourth lens L4 among the lights passing through the first lens L1. In this case, an end of the protruded portion 113a of the hood portion 113 may be disposed closer to the object than an imaginary lens surface (ISF1 indicated by a narrow dotted line) of a portion of the second lens L2, which is removed when the second hole H2 is formed, is.

In one or more embodiments, the third hole H3 of the hood portion 113 may have a size and shape that allows the light traveling on the normal path to pass therethrough. In one or more embodiments, when the diameter of the third hole H3 has the third diameter D3, the third diameter D3 may be equal to or smaller than an effective diameter of the fourth lens L4.

In one or more embodiments, an outer side surface of the hood portion 113 may contact a side surface of the second lens L2 defining the second hole H2 or may be disposed adjacent to the side surface defining the second hole H2 of the second lens L2 without contacting the side surface of the second lens L2 defining the second hole H2.

At least a portion of the hood portion 113 may be disposed such that the inner side surface defining the third hole H3 is inclined with respect to the optical axis AX. Accordingly, the at least the portion of the hood portion 113 may have a funnel shape. At an end portion of the hood portion 113, which is closest to the third lens L3, the diameter of the inner side surface defining the third hole H3 may decrease in a direction from the object to the image surface IMS. In addition, as shown in FIG. 3, an intermediate portion of the hood portion 113, which connects the end close to the third lens L3, may have a diameter that increases as a distance from the third lens L3 increases.

The inclination of the inner side surface and/or the outer side surface of the hood portion 113 with respect to the optical axis AX may be set differently depending on the path of the light reflected by the second lens L2 and the third lens L3. In one or more embodiments, the inclination of the inner surface and/or the outer surface of the hood portion 113 may be set not to allow the hood portion 113 to be disposed on the path of the light reflected by the second lens L2 and the third lens L3 when the light traveling on the normal path is sequentially reflected by the second lens L2 and the third lens L3.

According to one or more embodiments, a length from the end of the hood portion 113 to the image surface IMS of the image sensor 140 may be defined by Equation (5).

$$TTL \times 0.9 > HL > TTL \times 0.5 \qquad ( 5 )$$

In Equation (5), TTL denotes the length from the object-side surface L11 of the first lens L1 to the image surface IMS of the image sensor 140 in the optical axis AX, and HL denotes the length from the protruded portion 113a of the hood portion 113 to the image surface IMS of the image sensor 140. When a length of the hood portion 113 is equal to or smaller than 0.5×TTL, the light traveling on the abnormal path may not be sufficiently blocked, and when the length of the hood portion 113 is equal to or greater than 0.9×TTL, the light traveling on the normal path may be blocked.

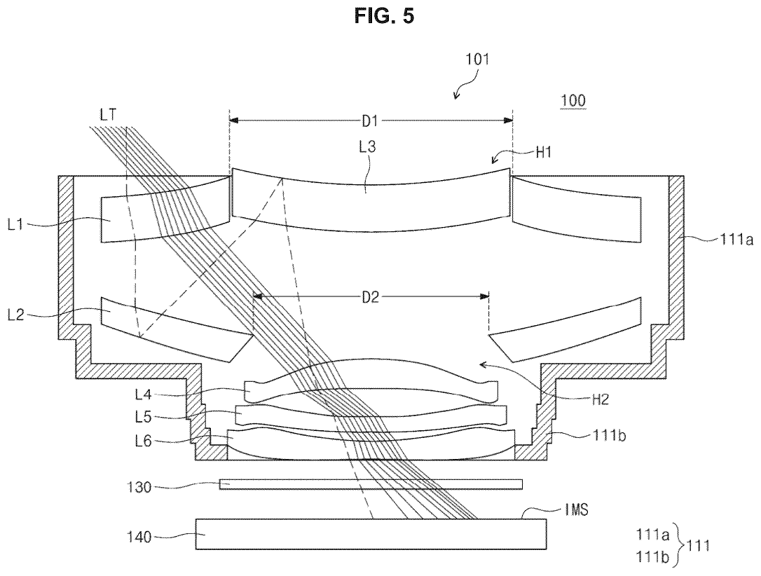

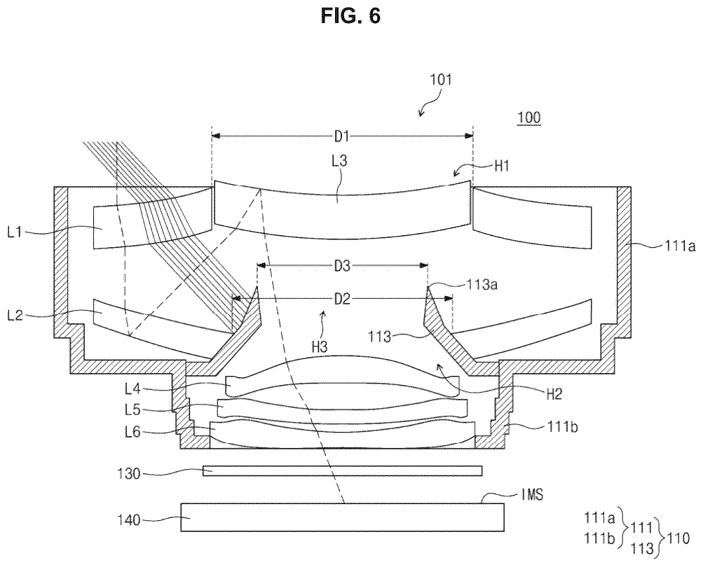

FIG. 5 is a cross-sectional view illustrating a camera module and illustrating a normal path and an abnormal path of a light incident into the camera module. FIG. 6 is a cross-sectional view illustrating a camera module and illustrating a normal path and an abnormal path of a light incident into the camera module according to one or more embodiments.

Referring to FIG. 5, in the camera module 100 that does not include the hood portion, a portion (indicated by a dotted line) of the light LT incident into a first lens L1 may travel sequentially through first, second, third, fourth, fifth, and sixth lenses L1, L2, L3, L4, L5, and L6. However, another portion (indicated by solid lines) of the light LT incident into the first lens L1 may travel directly to the fourth lens L4 through a second hole H2 of the second lens L2 without passing through the second lens L2 and the third lens L3 after passing through the first lens L1. Particularly, a light traveling outside an angle of view (i.e., a light that travels at a greater inclination angle with respect to an object-side surface of the first lens L1 among the lights incident into the first lens L1) may have a higher probability of traveling directly to the fourth lens L4. The light traveling outside the angle of view may appear as a flare in the image sensor 140 and may deteriorate an image quality. In a case where the light traveling on the abnormal path reaches the image sensor 140 after passing through the second hole H2, the image sensor 140 may detect the light passing through the abnormal path and the light passing through the normal path in a substantially simultaneous manner, and thus, the image obtained by the image sensor 140 may be different from an actual original object. As a result, a modulation transfer function (MTF) of the lens assembly may be deteriorated.

Referring to FIG. 6, in the camera module 100 in one or more embodiments, a portion (indicated by a dotted line) of the light LT incident into the first lens L1 may travel sequentially through the first, second, third, fourth, fifth, and sixth lenses L1, L2, L3, L4, L5, and L6. The light traveling outside the angle of view (as indicated by the solid lines) (i.e., the light that travels at a greater inclination angle with respect to the object-side surface of the first lens L1 among the lights incident into the first lens L1) may be blocked by the hood portion 113, and thus may not travel to the fourth lens LA.

As described above, in the camera module 100 in one or more embodiments, the light traveling on paths other than the paths passing through all the first, second, third, fourth, fifth, and sixth lenses L1, L2, L3, L4, L5, and L6 may be reduced, and a flare defect due to the light traveling on the paths other than the paths passing through all the first, second, third, fourth, fifth, and sixth lenses L1, L2, L3, L4, L5, and L6 may be reduced. In addition, the deterioration of the MTF may be reduced or prevented.

According to one or more embodiments, the housing and the lens assembly of the camera module may be modified in various ways. In the following description, aspects that are the same as or similar to those described above may be omitted.

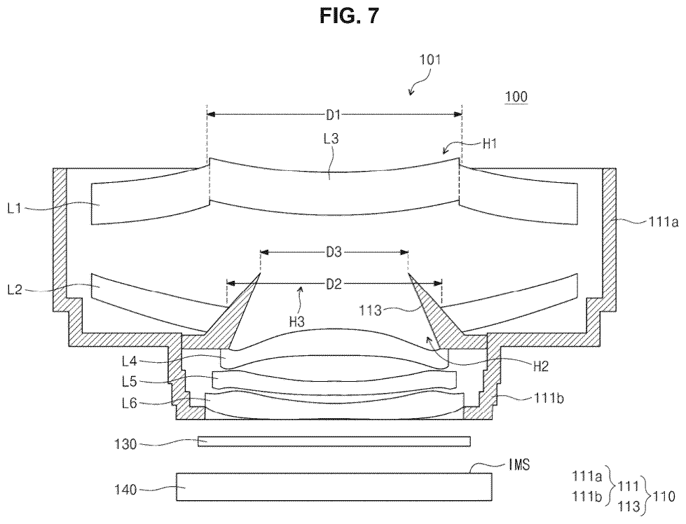

FIG. 7 is a cross-sectional view illustrating a camera module 100 according to one or more embodiments.

Referring to FIG. 7, the camera module 100 may include first, second, third, fourth, fifth, and sixth lenses L1, L2, L3, L4, L5, and L6, and at least one of the first, second, third, fourth, fifth, and sixth lenses L1, L2, L3, L4, L5, and L6 may have a different shape from those of the first to sixth lenses L1 to L6 of the above-described embodiments. In one or more embodiments, the first lens L1 and the third lens L3 may be provided integrally with each other without being separated from each other. In the case where the first lens L1 is provided integrally with the third lens L3, there is no need to manufacture two lenses separately and assemble the two lenses, and thus processes and costs may be reduced. In this case, an object-side surface of a portion corresponding to the third lens L3 may be formed as a reflective layer to reflect a light.

In addition, the camera module 100 may include a hood portion 113, and the hood portion 113 may have a shape different from that of the above-described embodiments. In one or more embodiments, an inner side surface of the hood portion 113, which defines a third hole H3, may have a diameter that increases from an object side to an image side. The shape of the inner side surface of the hood portion 113, which defines the third hole H3, is not limited thereto. According to one or more embodiments, the shape of the third hole H3 may be set differently depending on the design of the lenses and an optical path.

In addition, another lens may be added to the first, second, third, fourth, fifth, and sixth lenses L1, L2, L3, L4, L5, and L6. According to one or more embodiments, one or more lenses of the fourth lens LA, the fifth lens L5, and the sixth lens L6 may be omitted.

According to one or more embodiments, an efficiency of the light traveling on the normal path may increase and the light traveling on the abnormal path may be blocked by adjusting the number of the lenses, the shape of the lenses, and/or the shape of the hood portion. Since the light traveling on the abnormal path is blocked, the flare defect may be prevented from occurring in the image obtained by the image sensor.

Further, the camera module may be configured to allow the TTL to decrease and to allow the total effective focal length f to increase. Accordingly, the camera module may achieve high magnification with a relatively small size.

The camera module according to one or more embodiments may be applied to various electronic devices. The electronic device, for example, may include at least one of a smartphone, a table personal computer (PC), a mobile phone, a video phone, an e-book reader, a desktop PC, a laptop PC, a netbook computer, a workstation, a server, a personal digital assistant (PDA), a portable multimedia player (PMP), an MPEG audio layer 3 (MP3) player, a mobile medical device, a camera, and a wearable device. According to one or more embodiments, the wearable device may be implemented in at least one of an accessory type (e.g., a watch, a ring, a bracelet, an anklet, a necklace, glasses, a contact lens, or a head-mounted-device (HMD)), a fabric or clothing integration type (e.g., an electronic garment), a body attachment type (e.g., a skin pad or a tattoo), and a bio-implantable type (e.g., an implantable circuit).

In one or more embodiments, the electronic device may be a home appliance. The home appliance, for example, may include at least one of a television (TV), a digital video disk (DVD) player, an audio device, a refrigerator, an air conditioner, a vacuum cleaner, an oven, a microwave, a washer, an air cleaner, a set-top box, a home automation control panel, a security control panel, a TV box (e.g., Samsung HomeSync™, Apple TV™, or Google TV™), a game console (e.g., Xbox™ or PlayStation™), an electronic dictionary, an electronic key, a camcorder, and an electronic picture frame.

In one or more embodiments, the electronic device, for example, may include at least one of various medical devices (e.g., various portable medical measurement devices (a glucometer, a heart rate meter, a blood pressure meter, a temperature gauge, etc.), a magnetic resonance angiography (MRA) device, a magnetic resonance imaging (MRI) device, a computed tomography (CT) device, a shooting device, an ultrasonic machine, etc.), a navigation device, a satellite navigation system (global navigation satellite system (GNSS)), an event data recorder (EDR), a flight data recorder (FDR), a car infotainment device, a marine electronic device (e.g., a marine navigation device, a gyro compass, or the like), avionics, a security device, a car head unit, an industrial or home robot, an automated teller machine (ATM) of a financial institution, a point of sales (POS) terminal of a shop, and Internet of things (e.g., a bulb, various sensors, an electric or gas meter, a sprinkler system, a fire alarm, a thermostat, a street light, a toaster, an exercise equipment, a hot water tank, a heater, a boiler, etc.).

In one or more embodiments, the electronic device, for example, may include at least one of a portion of furniture or a building/structure, an electronic board, an electronic signature receiving device, a projector, and various measurement devices (for example, water, electricity, gas, and electric wave measuring devices). In one or more embodiments, the electronic device may be one of the above-described devices or a combination of the devices. According to one or more embodiments, the electronic device may be flexible electronic devices. In addition, the electronic device is not limited thereto and may include new electronic devices according to the development of technologies.

Table 1 shows specifications of a lens assembly, and Table 2 shows design data of the lens assembly shown in FIG. 4. In Table 1 below, EFL denotes an effective focal length of the lens assembly, Fno denotes the number of F, HFOV denotes a horizontal field of view, NPmax denotes a maximum value of a lens refractive index, V1 to V5 denote aberration values of first to fifth lenses, respectively, N1 to N5 denote refractive indices of the first to fifth lenses, respectively, f denotes a focal length of the lens assembly, and f1 to f4 respectively denote focal lengths of the first, third, fourth, and fifth lenses. In Table 2, the unit of distance is millimeters (mm).

TABLE 1

| | |
|---|---|
| EFL | 13.6 |
| Fno | 1.8 |
| HFOV | 10.5 |
| NPmax | 1.68 |
| V1/N1 | 36.22 |
| V2/N2 | 36.22 |
| V3/N3 | 36.22 |
| V4/N4 | 11.47 |
| V5/N5 | 36.25 |
| f1/f | 4.0838 |
| f2/f | 0.7565 |
| f3/f | −4.4815 |
| f4/f | −0.7220 |

TABLE 2

| | Lens | Diameter | Thickness | Nd | Vd | Y aperture | Focal length |
|---|---|---|---|---|---|---|---|
| S1 (L11) | First lens | 8.463399684 | 1.0935724 | 1.545785042 | 55.99006859 | 4.6129575 | 55.540177 |
| S2 (L13) | | 11.20600114 | 2.3250047 | | | 4.6481616 | |
| S3 (L21) | second lens(L2) | −12.65128087 | 0.5610367 | 1.545785042 | 55.99006859 | 4.6037863 | −6.799907 |
| | (incidence) | | | | | | |
| S4 (L23) | second lens(L2) | −11.60954421 | −0.561037 | −1.545785042 | 55.99006859 | 4.6538131 | |
| S5 (L21) | second lens(L2) | −12.65128087 | −1.988182 | −1 | 0 | 4.3439607 | |
| | (emission) | | | | | | |
| S6 (L31) | third lens(L3) | −35.31568294 | −0.825696 | −1.545785042 | 55.99006859 | 2.48 | −4.354885 |
| | (incidence) | | | | | | |
| S7 (L33) | third lens(L3) | −8.277474385 | 0.8256961 | 1.545785042 | 55.99006859 | 1.8709682 | |
| S8 (L31) | third lens(L3) | −35.31568294 | 2.2492286 | | | 1.752927 | |
| | (emission) | | | | | | |
| S9 (L41) | fourth lens | 4.737599817 | 0.5524235 | 1.545785042 | 55.99006859 | 2.148384 | 10.28855 |
| S10 (L43) | | 29.06105088 | 0.4724473 | | | 2.3067344 | |
| S11 (L51) | fifth lens | 22.82891481 | 0.29809 | 1.676943937 | 19.23796972 | 2.337421 | −60.94798 |
| S12 (L53) | | 14.61942174 | 0.2474151 | | | 2.4349861 | |
| S13 (L61) | sixth lens | −5.018177663 | 0.3 | 1.5367863 | 55.70980621 | 2.4612262 | −9.819778 |
| S14 (L63) | | −106.7575628 | 0.381979 | | | 2.4288304 | |
| S15 (131) | optic device | 1E+18 | 0.21 | 1.518274025 | 64.16641024 | 3.9998354 | −1E+35 |
| S16 (133) | | 1E+18 | 0.3731196 | | | 3.9420065 | |

Table 3 shows aspheric coefficient values of a lens surface in the lens assembly.

TABLE 3

| Sur- | | | | | | | | | | |
|---|---|---|---|---|---|---|---|---|---|---|
| face | K | A | B | C | D | E | F | G | H | J |
| S1 | −10.73713 | 0.0014458 | −0.000151 | 7.814E−06 | 4.6E−07 | 1.65E−08 | −3.04E−10 | 2.299E−12 | 0 | 0 |
| (L11) | | | | | | | | | | |
| S2 | −27.68571 | 0.0014759 | −6.49E−06 | −0.000101 | 3.771E−05 | −8.53E−06 | 1.332E−06 | −1.49E−07 | 1.222E−08 | −7.3E−10 |
| (L13) | | | | | | | | | | |
| S3 | 0 | 0 | 0 | 0 | 0 | 0 | 0 | 0 | 0 | 0 |
| (L21) | | | | | | | | | | |
| S4 | 0 | 0 | 0 | 0 | 0 | 0 | 0 | 0 | 0 | 0 |
| (L23) | | | | | | | | | | |
| S5 | 0 | 0 | 0 | 0 | 0 | 0 | 0 | 0 | 0 | 0 |
| (L21) | | | | | | | | | | |
| S6 | 29.841209 | −0.002211 | 9.974E−05 | 5.807E−07 | −1.01E−06 | −1.41E−08 | −2.89E−09 | 8.091E−10 | 1.219E−10 | −1.1E−11 |
| (L31) | | | | | | | | | | |
| S7 | 1.8804196 | −0.000113 | −2.23E−05 | 2.723E−05 | −5.72E−06 | 5.987E−08 | 1.453E−07 | −5.22E−08 | 7.401E−09 | 1.419E−10 |
| (L33) | | | | | | | | | | |
| S8 | 29.841209 | −0.002211 | 9.974E−05 | 5.807E−07 | −1.01E−06 | −1.41E−08 | −2.89E−09 | 8.091E−10 | 1.219E−10 | −1.1E−11 |
| (L31) | | | | | | | | | | |
| S9 | −1.59141 | −0.02301 | 0.1101424 | −0.295879 | 0.5632491 | −0.741824 | 0.6822184 | −0.445227 | 0.2086179 | −0.070399 |
| (L41) | | | | | | | | | | |
| S10 | 71.383781 | −0.047861 | 0.1403329 | −0.234172 | 0.3583407 | −0.448887 | 0.4098942 | −0.263937 | 0.1199592 | −0.03862 |
| (L43) | | | | | | | | | | |
| S11 | 80.601275 | −0.231038 | 0.4826917 | −0.624259 | 0.6401487 | −0.587231 | 0.4521736 | −0.265822 | 0.1141407 | −0.035252 |
| (L51) | | | | | | | | | | |
| S12 | −32.47134 | −0.232365 | 0.4802292 | −0.551579 | 0.443104 | −0.311937 | 0.2046764 | −0.111632 | 0.0457416 | −0.01351 |
| (L53) | | | | | | | | | | |
| S13 | 0 | 0.0612729 | −0.047385 | −0.002637 | 0.0202894 | −0.010997 | 0.0027689 | −0.000364 | 2.355E−05 | −5.68E−07 |
| (L61) | | | | | | | | | | |
| S14 | 0 | 0.1360663 | −0.211753 | 0.1613044 | −0.073122 | 0.0206776 | −0.003665 | 0.0003932 | −2.31E−05 | 5.66E−07 |
| (L63) | | | | | | | | | | |
| S15 | 0 | 0 | 0 | 0 | 0 | 0 | 0 | 0 | 0 | 0 |
| (131) | | | | | | | | | | |
| S16 | 0 | 0 | 0 | 0 | 0 | 0 | 0 | 0 | 0 | 0 |
| (133) | | | | | | | | | | |

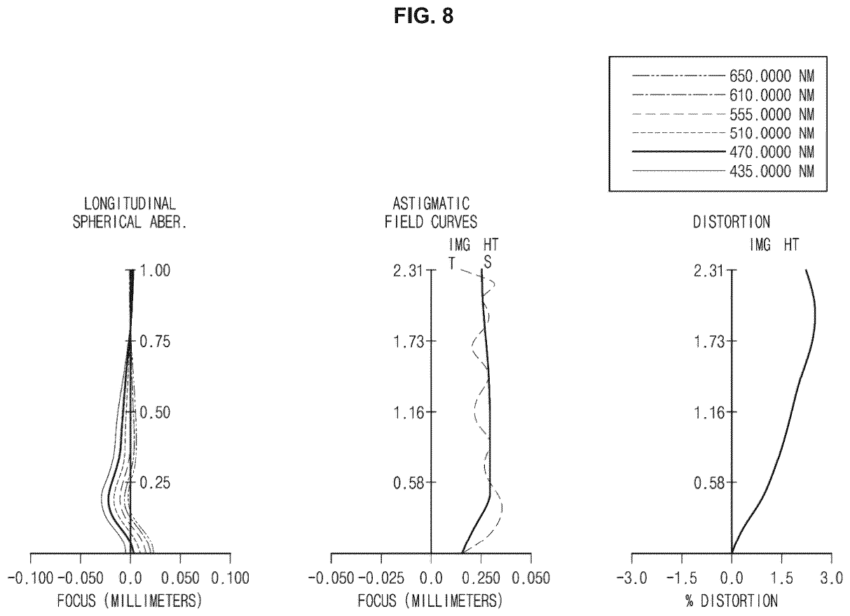

FIG. 8 is a graph illustrating a longitudinal spherical aberration, astigmatic field curves, and a distortion aberration of the lens assembly according to one or more embodiments. The longitudinal spherical aberrations with respect to lights respectively having wavelengths of about 650.0 nanometers, about 610.0 nanometers, about 555.0 nanometers, about 510.0 nanometers, about 470.0 nanometers, and about 435.0 nanometers are shown, and a tangential field curvature (T) and a sagittal field curvature(S) are shown as the astigmatic field curves. The astigmatic field curves are shown with respect to the light having the wavelength of about 555.0 nanometers, and the distortion aberration is shown with respect to the light having the wavelength of about 555.0 nanometers.

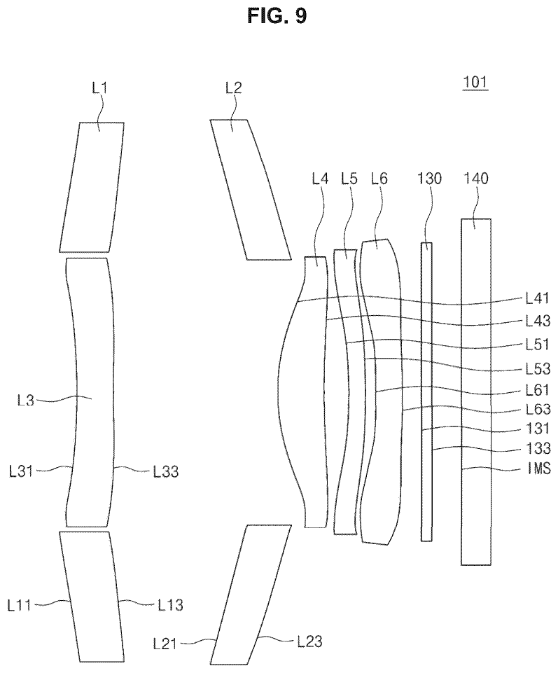

FIG. 9 is a cross-sectional view illustrating a lens assembly according to one or more embodiments. FIG. 9 shows a lens assembly 101 utilizing lenses different sizes, different types, and with varied openings.

Table 4 shows specifications of the lens assembly, and Table 5 shows design data of the lens assembly shown in FIG. 9. In Table 4 below, EFL denotes an effective focal length of the lens assembly, Fno denotes the number of F, HFOV denotes a horizontal field of view, NPmax denotes a maximum value of a lens refractive index, V1 to V5 denote aberration values of first to fifth lenses, respectively, N1 to N5 denote refractive indices of the first to fifth lenses, respectively, f denotes a focal length of the lens assembly, and f1 to f4 respectively denote focal lengths of the first, third, fourth, and fifth lenses. In Table 5, the unit of distance is millimeters (mm).

TABLE 4

| | |
|---|---|
| EFL | 14.7 |
| Fno | 1.458830985 |
| HFOV | 32.32816038 |
| NPmax | 1.68 |
| V1/N1 | 36.22 |
| V2/N2 | 36.22 |
| V3/N3 | 36.22 |
| V4/N4 | 11.47 |
| V5/N5 | 36.25 |
| f1/f | 5.3787 |
| f2/f | 0.6036 |
| f3/f | −2.8468 |
| f4/f | −0.8409 |

TABLE 5

| | | | | | | | Focal |
|---|---|---|---|---|---|---|---|
| Surface | Lens | Radius | Thickness | Nd | Vd | Y Aperture | Length |
| S1 (L11) | first lens | 14.180182 | 1 | 1.545785 | 55.990069 | 5.0382807 | 79.067595 |
| S2 (L13) | | 20.594296 | 2.8050284 | | | 5.0068898 | |
| S3 (L21) | second lens(L2) | −15.52571 | 0.8 | 1.545785 | 55.990069 | 4.9817159 | −8.183274 |
| | (incidence) | | | | | | |
| S4 (L23) | second lens(L2) | −14.04966 | −0.8 | 1.545785 | 1.545785 | 5.0551925 | |
| S5 (L21) | second lens(L2) | −15.52571 | −2.592506 | | | 4.6415716 | |
| | (emission) | | | | | | |
| S6 (L31) | third lens(L3) | −73.51669 | −0.652126 | 1.545785 | 1.545785 | 2.4999995 | −5.425065 |
| | (incidence) | | | | | | |
| S7 (L33) | third lens(L3) | −10.54149 | 0.6521256 | 1.545785 | 55.990069 | 2.0906459 | |
| S8 (L31) | third lens(L3) | −73.51669 | 2.9732705 | | | 2.0221627 | |
| | (emission) | | | | | | |
| S9 (L41) | fourth lens | 4.585729 | 0.8374599 | 1.545785 | 55.990069 | 2.35 | 8.8735945 |
| S10 (L43) | | 80.735553 | 0.4345726 | | | 2.5366055 | |
| S11 (L51) | fifth lens | 22.662393 | 0.3 | 1.6769439 | 19.23797 | 2.2816581 | −41.84868 |
| S12 (L53) | | 12.523179 | 0.1863343 | | | 2.2704922 | |
| S13 (L61) | sixth lens | −7.248627 | 0.4517181 | 1.5367863 | 55.709806 | 2.2667786 | −12.36186 |
| S14 (L63) | | 80.180439 | 0.4 | | | 2.2527326 | |
| S15 (131) | optic device | 1E+18 | 0.21 | 1.518274 | 64.16641 | 2.1934584 | −1E+35 |
| S16 (133) | | 1E+18 | 0.3804251 | | | 2.1743041 | |

Table 6 shows aspheric coefficient values of a lens surface in the lens assembly.

TABLE 6

| Sur- | | | | | | | | | | |
|---|---|---|---|---|---|---|---|---|---|---|
| face | K | A | B | C | D | E | F | G | H | J |
| S1 | −19.92734 | 0.0004569 | −4.14E−05 | 1.72E−06 | −7.18E−08 | 2.408E−09 | −4.76E−11 | 4.071E−13 | 0 | 0 |
| (L11) | | | | | | | | | | |
| S2 | −41.86191 | 0.0002989 | −4.67E−05 | 9.511E−06 | −2.33E−06 | 4.014E−07 | −4.54E−08 | 3.194E−09 | −1.08E−10 | −2.53E−12 |
| (L13) | | | | | | | | | | |
| S3 | 0 | 0 | 0 | 0 | 0 | 0 | 0 | 0 | 0 | 0 |
| (L21) | | | | | | | | | | |
| S4 | 0 | 0 | 0 | 0 | 0 | 0 | 0 | 0 | 0 | 0 |
| (L23) | | | | | | | | | | |
| S5 | 0 | 0 | 0 | 0 | 0 | 0 | 0 | 0 | 0 | 0 |
| (L21) | | | | | | | | | | |
| S6 | 95.040335 | −0.001997 | −1.99E−07 | 1.267E−06 | 5.172E−07 | −1.91E−08 | −4.73E−09 | −2.41E−11 | 4.715E−11 | −1.59E−12 |
| (L31) | | | | | | | | | | |
| S7 | 1.8840702 | −3.44E−06 | −4.02E−05 | 1.078E−05 | −9.14E−07 | −5.28E−08 | 2.939E−08 | −5.59E−10 | −6.31E−10 | 5.909E−11 |
| (L33) | | | | | | | | | | |
| S8 | 95.040335 | −0.001997 | −1.99E−07 | 1.267E−06 | 5.172E−07 | −1.91E−08 | −4.73E−09 | −2.41E−11 | 4.715E−11 | −1.59E−12 |
| (L31) | | | | | | | | | | |
| S9 | −1.410402 | −0.007255 | 0.0295009 | −0.067549 | 0.1093425 | −0.122523 | 0.096071 | −0.053752 | 0.0217552 | −0.006391 |
| (L41) | | | | | | | | | | |
| S10 | 97.981092 | −0.042975 | 0.0841192 | −0.096339 | 0.0995614 | −0.09084 | 0.0621135 | −0.029669 | 0.0097873 | −0.002224 |
| (L43) | | | | | | | | | | |
| S11 | 65.585375 | −0.231609 | 0.400873 | −0.443988 | 0.4070669 | −0.33797 | 0.2269545 | −0.112252 | 0.0397057 | −0.009977 |
| (L51) | | | | | | | | | | |
| S12 | 20.66437 | −0.211681 | 0.356257 | −0.347823 | 0.2490635 | −0.16616 | 0.1009185 | −0.048052 | 0.0165979 | −0.004066 |
| (L53) | | | | | | | | | | |
| S13 | 0 | 0.0723365 | −0.091004 | 0.0544584 | −0.02116 | 0.0060655 | −0.001259 | 0.0001711 | −1.32E−05 | 4.269E−07 |
| (L61) | | | | | | | | | | |
| S14 | 0 | 0.1248292 | −0.184489 | 0.1292973 | −0.053431 | 0.0138077 | −0.002257 | 0.0002265 | −1.27E−05 | 3.058E−07 |
| (L63) | | | | | | | | | | |
| S15 | 0 | 0 | 0 | 0 | 0 | 0 | 0 | 0 | 0 | 0 |
| (131) | | | | | | | | | | |
| S16 | 0 | 0 | 0 | 0 | 0 | 0 | 0 | 0 | 0 | 0 |
| (133) | | | | | | | | | | |

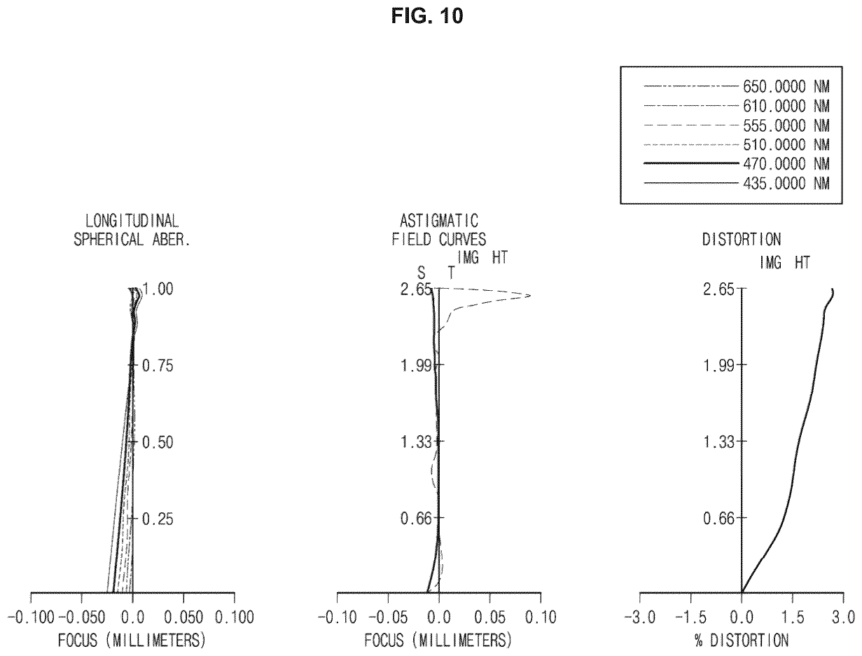

FIG. 10 is a graph illustrating a longitudinal spherical aberration, astigmatic field curves, and a distortion aberration of the lens assembly according to one or more embodiments. That is, FIG. 10 may correspond to FIG. 9.

The longitudinal spherical aberrations with respect to lights respectively having wavelengths of about 650.0 nanometers, about 610.0 nanometers, about 555.0 nanometers, about 510.0 nanometers, about 470.0 nanometers, and about 435.0 nanometers are shown, and a tangential field curvature (T) and a sagittal field curvature(S) are shown as the astigmatic field curves. The astigmatic field curves are shown with respect to the light having the wavelength of about 555.0 nanometers, and the distortion aberration is shown with respect to the light having the wavelength of about 555.0 nanometers.

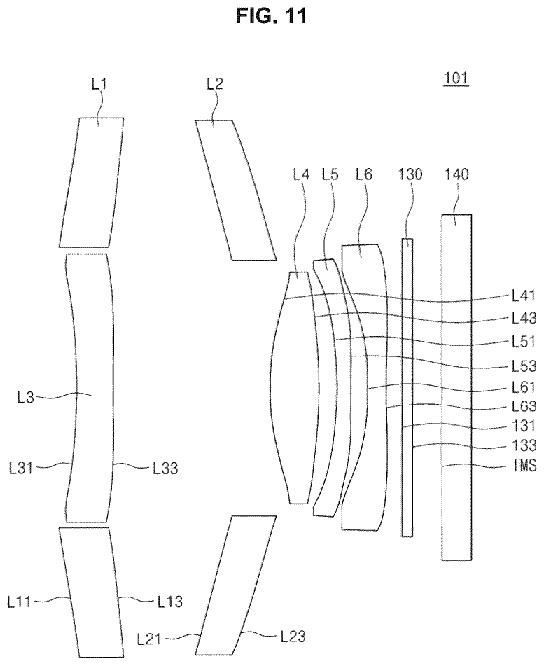

FIG. 11 is a cross-sectional view illustrating a lens assembly according to one or more embodiments. FIG. 11 shows a lens assembly 101 utilizing lenses different sizes, different types, and with varied openings.

Table 7 shows specifications of the lens assembly, and Table 8 shows design data of the lens assembly shown in FIG. 11. In Table 7 below, EFL denotes an effective focal length of the lens assembly, Fno denotes the number of F, HFOV denotes a horizontal field of view, NPmax denotes a maximum value of a lens refractive index, V1 to V5 denote aberration values of first to fifth lenses, respectively, N1 to N5 denote refractive indices of the first to fifth lenses, respectively, f denotes a focal length of the lens assembly, and f1 to f4 respectively denote focal lengths of the first, third, fourth, and fifth lenses. In Table 8, the unit of distance is millimeters (mm).

TABLE 7

| | |
|---|---|
| EFL | 16 |
| Fno | 1.74 |
| HFOV | 9.98 |
| NPmax | 1.68 |
| V1/N1 | 36.22 |
| V2/N2 | 36.22 |
| V3/N3 | 36.22 |
| V4/N4 | 11.47 |
| V5/N5 | 36.25 |
| f1/f | 5.3037 |
| f2/f | 0.5581 |
| f3/f | −2.2725 |
| f4/f | −0.5942 |

TABLE 8

| Surface | Lens | Radius | Thickness | Nd | Vd | Y Aperture | Focal Length |
|---|---|---|---|---|---|---|---|
| S1 (L11) | first lens | 21.862413 | 1.0190068 | 1.545785 | 55.990069 | 5.5423507 | 82.738495 |
| S2 (L13) | | 41.682868 | 3.04587 | | | 5.5051386 | |
| S3 (L21) | second lens(L2) | −16.29898 | 0.8038404 | 1.545785 | 55.990069 | 5.4836553 | −8.956237 |
| | (incidence) | | | | | | |
| S4 (L23) | second lens(L2) | −15.2631 | −0.80384 | 1.545785 | 55.990069 | 5.5658964 | |
| S5 (L21) | second lens(L2) | −16.29898 | −2.796237 | | | 5.1397222 | |
| | (emission) | | | | | | |
| S6 (L31) | third lens(L3) | −31.77136 | −0.801007 | 1.545785 | 55.990069 | 2.8491207 | −5.923043 |
| | (incidence) | | | | | | |
| S7 (L33) | third lens(L3) | −11.01555 | 0.8010071 | 1.545785 | 55.990069 | 2.3215149 | |
| S8 (L31) | third lens(L3) | −31.77136 | 3.2837372 | | | 2.2044268 | |
| | (emission) | | | | | | |
| S9 (L41) | fourth lens | 5.8593573 | 1.0146884 | 1.545785 | 55.990069 | 2.3958983 | 8.7061153 |
| S10 (L43) | | −23.59809 | 0.4151528 | | | 2.4847219 | |
| S11 (L51) | fifth lens | 28.78868 | 0.3 | 1.6769439 | 19.23797 | 2.5490233 | −35.45058 |
| S12 (L53) | | 13.032935 | 0.3174888 | | | 2.5883192 | |
| S13 (L61) | sixth lens | −5.070396 | 0.4 | 1.5367863 | 55.709806 | 2.6203324 | −9.268766 |
| S14 (L63) | | 272.72327 | 0.4 | | | 2.7546017 | |
| S15 (131) | optic device | | 0.21 | 1.518274 | 64.16641 | 2.8208063 | −1E+35 |
| S16 (133) | | | 0.3770745 | | | 2.8413018 | |

Table 9 shows aspheric coefficient values of a lens surface in the lens assembly.

TABLE 9

| Sur- | | | | | | | | | | |
|---|---|---|---|---|---|---|---|---|---|---|
| face | K | A | B | C | D | E | F | G | H | J |
| S1 | −39.6234 | 0.0002043 | −2.79E−05 | 1.918E−06 | −9.8E−08 | 3.237E−09 | −5.73E−11 | 4.139E−13 | 0 | 0 |
| (L11) | | | | | | | | | | |
| S2 | −97.43628 | 1.523E−05 | −3.35E−05 | 7.764E−06 | −1.07E−06 | 5.803E−08 | 6.42E−09 | −1.59E−09 | 1.591E−10 | −9.73E−12 |
| (L13) | | | | | | | | | | |
| S3 | 0 | 0 | 0 | 0 | 0 | 0 | 0 | 0 | 0 | 0 |
| (L21) | | | | | | | | | | |
| S4 | 0 | 0 | 0 | 0 | 0 | 0 | 0 | 0 | 0 | 0 |
| (L23) | | | | | | | | | | |
| S5 | 0 | 0 | 0 | 0 | 0 | 0 | 0 | 0 | 0 | 0 |
| (L21) | | | | | | | | | | |
| S6 | 8.1705237 | −0.001394 | 2.653E−06 | −1.49E−06 | 6.278E−07 | −1.37E−08 | −4.78E−09 | −7.17E−11 | 4.715E−11 | −1.59E−12 |
| (L31) | | | | | | | | | | |
| S7 | 1.8989392 | −1.94E−06 | −1.76E−05 | 5.337E−06 | −3.18E−07 | −5.89E−08 | 2.412E−08 | −5.59E−10 | −6.31E−10 | 5.909E−11 |
| (L33) | | | | | | | | | | |
| S8 | 8.1705237 | −0.001394 | 2.653E−06 | −1.49E−06 | 6.278E−07 | −1.37E−08 | −4.78E−09 | −7.17E−11 | 4.715E−11 | −1.59E−12 |
| (L31) | | | | | | | | | | |
| S9 | −3.632352 | −0.004235 | 0.0077238 | −0.003945 | −0.005753 | 0.0140311 | −0.014935 | 0.0099441 | −0.004492 | 0.0014135 |
| (L41) | | | | | | | | | | |
| S10 | −84.48934 | −0.044136 | 0.0647699 | −0.054446 | 0.0326293 | −0.015403 | 0.004492 | 0.0003954 | −0.001149 | 0.0005886 |
| (L43) | | | | | | | | | | |
| S11 | −12.2959 | −0.208173 | 0.347252 | −0.377784 | 0.3196038 | −0.228901 | 0.1328496 | −0.058657− | 0.0190201 | −0.004443 |
| (L51) | | | | | | | | | | |
| S12 | 20.819791 | −0.185664 | 0.3193875 | −0.332073 | 0.2416363 | −0.143298 | 0.0717607 | −0.028863 | 0.0088278 | −0.001984 |
| (L53) | | | | | | | | | | |
| S13 | 0 | 0.0683763 | −0.045409 | −0.008091 | 0.0191232 | −0.008679 | 0.0019673 | −0.000246 | 1.629E−05 | −4.45E−07 |
| (L61) | | | | | | | | | | |
| S14 | 0 | 0.1088395 | −0.1262 | 0.0692099 | −0.022103 | 0.0043726 | −0.000544 | 4.164E−05 | −1.79E−06 | 3.327E−08 |
| (L63) | | | | | | | | | | |
| S15 | 0 | 0 | 0 | 0 | 0 | 0 | 0 | 0 | 0 | 0 |
| (131) | | | | | | | | | | |
| S16 | 0 | 0 | 0 | 0 | 0 | 0 | 0 | 0 | 0 | 0 |
| (133) | | | | | | | | | | |

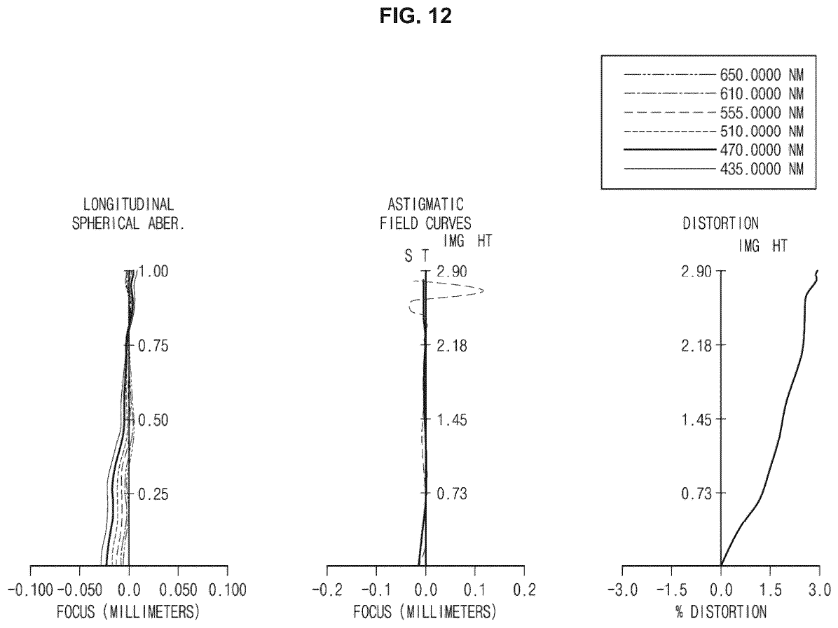

FIG. 12 is a graph illustrating a longitudinal spherical aberration, astigmatic field curves, and a distortion aberration of the lens assembly according to one or more embodiments. That is, FIG. 12 may correspond to FIG. 11.

The longitudinal spherical aberrations with respect to lights respectively having wavelengths of about 650.0 nanometers, about 610.0 nanometers, about 555.0 nanometers, about 510.0 nanometers, about 470.0 nanometers, and about 435.0 nanometers are shown, and a tangential field curvature (T) and a sagittal field curvature(S) are shown as the astigmatic field curves. The astigmatic field curves are shown with respect to the light having the wavelength of about 555.0 nanometers, and the distortion aberration is shown with respect to the light having the wavelength of about 555.0 nanometers.

According to one or more embodiments, the camera module achieves high magnification while reducing a total length. In addition, the light traveling to an abnormal path in the lens assembly is blocked, and thus, defects such as flare are prevented in the camera module.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

At least one of the devices, units, components, modules, units, or the like represented by a block or an equivalent indication in the above embodiments including, but not limited to, FIGS. 1 and 2 may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. A camera module comprising:
a lens assembly comprising a plurality of lenses along a first optical path; and
an image sensor comprising an image surface and provided at one side of the lens assembly,
wherein the plurality of lenses comprise:
a first lens comprising a first hole through a center thereof;
a second lens adjacent to an image-side surface of the first lens, the second lens configured as a reflective type lens, and comprising a second hole through a center thereof;
a third lens adjacent to the first lens and configured as a reflective type lens;
a fourth lens adjacent to an image-side surface of the third lens; and
a fifth lens adjacent to an image-side surface of the fourth lens, and
wherein the camera module satisfies 4>f/TTL>0.5 and 0.75>D1/CA>0.4, where f corresponds to a total effective focal length of the lens assembly, TTL corresponds to a total track length from an object-side surface of the first lens to the image surface of the image sensor, CA corresponds to an effective diameter of the object-side surface of the first lens, and D1 corresponds to a diameter of the first hole.

2. The camera module of claim 1, wherein the camera module further satisfies 0.75>D2/CA>0.4, where D2 corresponds a diameter of the second hole.

3. The camera module of claim 1, further comprising a housing accommodating the lens assembly and the image sensor,
wherein the housing comprises:
a cylindrical portion configured to support the first lens, the second lens, the third lens, the fourth lens, and the fifth lens; and
a hood portion comprising a protruded portion that protrudes from an inner side surface of the cylindrical portion.

4. The camera module of claim 3, wherein the hood portion is on a second optical path that directly connects the first lens and the fourth lens.

5. The camera module of claim 4, wherein the hood portion penetrates the second hole.

6. The camera module of claim 4, wherein the hood portion has a ring shape with a third hole defined through a center thereof, and
wherein an inner side surface of the hood portion defining the third hole is inclined with respect to an optical axis of the first lens, the second lens, the third lens, the fourth lens, and the fifth lens.

7. The camera module of claim 6, wherein the inner side surface of the hood portion has a diameter that decreases as a distance from an object increases.

8. The camera module of claim 6, wherein the inner side surface of the hood portion has a diameter that decreases as a distance from an object decreases.

9. The camera module of claim 3, wherein the hood portion is integral with the cylindrical portion.

10. The camera module of claim 3, wherein the camera module further satisfies TTL×0.9>HL>TTL×0.5, where HL denotes a length from an end of the protruded portion of the hood portion to the image surface of the image sensor.

11. The camera module of claim 1, wherein an image-side surface of the second lens is a reflective surface, and
wherein an object-side surface of the third lens is a reflective surface.

12. The camera module of claim 1, wherein the first lens has a positive refractive power,
wherein the image-side surface of the first lens has a concave shape,
wherein an image-side surface of the second lens has a convex shape,
wherein an object-side surface of the third lens has a concave shape,
wherein the fourth lens has a negative refractive power, and
wherein the image-side surface of the fourth lens has a concave shape.

13. The camera module of claim 1, wherein at least one of the second lens and the third lens is an aspherical lens.

14. The camera module of claim 1, wherein the first lens is integral with the third lens.

15. The camera module of claim 1, further comprising an optic device between the fifth lens and the image sensor.

16. A lens assembly comprising a plurality of lenses along an optical path, the plurality of lenses comprising:
a first lens comprising a first hole through a center thereof;
a second lens adjacent to an image-side surface of the first lens, the second lens configured as a reflective type lens, and comprising a second hole through a center thereof;
a third lens adjacent to the first lens and configured as a reflective type lens;
a fourth lens adjacent to an image-side surface of the third lens; and
a fifth lens adjacent to an image-side surface of the fourth lens,
wherein the lens assembly satisfies 4>f/TTL>0.5, 0.75>D1/CA>0.4, and 0.75>D2/CA>0.4, where f corresponds to a total effective focal length of the lens assembly, TTL corresponds to a total track length from an object-side surface of the first lens to a focus of the lens assembly, CA corresponds to an effective diameter of the object-side surface of the first lens, D1 corresponds to a diameter of the first hole, and D2 corresponds to a diameter of the second hole.

17. The lens assembly of claim 16, wherein an image-side surface of the second lens has a convex shape,
wherein the image-side surface of the second lens is a reflective surface, and
wherein an object-side surface of the third lens is a reflective surface having a concave shape.

18. The lens assembly of claim 17, wherein at least one of the second lens and the third lens is an aspherical lens.

19. The lens assembly of claim 16, further comprising a sixth lens having a positive refractive power and adjacent to an image-side surface of the fifth lens.

20. An electronic device comprising:
a camera module configured to obtain an image by photographing an object;
a processor configured to control the camera module to process the image; and
a memory configured to store the image,
wherein the camera module comprises:
a lens assembly comprising a plurality of lenses along an optical path; and
an image sensor comprising an image surface:
wherein the plurality of lenses comprise:
a first lens comprising a first hole through a center thereof;
a second lens adjacent to an image-side surface of the first lens, the second lens configured as a reflective type lens, and comprising a second hole through a center thereof;
a third lens adjacent to the first lens and configured as a reflective type lens;
a fourth lens adjacent to an image-side surface of the third lens; and
a fifth lens adjacent to an image-side surface of the fourth lens, and
wherein the camera module satisfies 4>f/TTL>0.5 and 0.75>D1/CA>0.4, where f corresponds to a total effective focal length of the lens assembly, TTL corresponds to a length from an object-side surface of the first lens to the image surface of the image sensor, CA corresponds to an effective diameter of the object-side surface of the first lens, and D1 corresponds to a diameter of the first hole.
